(19) United States
(12) Patent Application Publication
(10) Pub. No.: US 2023/0183524 A1
(43) Pub. Date: Jun. 15, 2023

(54) POLYAMINE COMPOSITE MATERIAL AND PREPARATION METHOD THEREFOR, SLURRY, SEPARATOR, ELECTRODE SHEET, AND LITHIUM-SULFUR BATTERY CONTAINING THE SAME

(71) Applicant: SOUTH CHINA NORMAL UNIVERSITY, Guangzhou, Guangdong (CN)

(72) Inventors: Weishan LI, Guangzhou (CN); Zhibin JIANG, Guangzhou (CN); Lidan XING, Guangzhou (CN); Youhao LIAO, Guangzhou (CN); Shiyu CHEN, Guangzhou (CN); Xiying JIAN, Guangzhou (CN); Jinxia HUANG, Guangzhou (CN)

(21) Appl. No.: 17/767,603

(22) PCT Filed: Dec. 29, 2020
(86) PCT No.: PCT/CN2020/140863

§ 371 Date: Jan. 18, 2023

(30) Foreign Application Priority Data
Jan. 15, 2020 (CN) 202010041044.4
Jan. 15, 2020 (CN) 202010041072.6

(51) Int. Cl. C09D 179/02; H01M 50/449; H01M 50/426; H01M 50/417; H01M 10/052; H01M 4/13

(52) U.S. Cl. CPC C09D 179/02; H01M 50/449; H01M 50/426; H01M 50/417; H01M 10/052; H01M 4/13

(57) ABSTRACT

The present disclosure relates to the technical field of batteries, and specifically relates to a polyamine composite material and a preparation method therefor, a slurry, a separator, an electrode sheet, and a lithium-sulfur battery containing the same. The polyamine composite material comprises a carboxylated carbon-based material serving as a substrate and a polyamine serving as an outer surface layer, and the polyamine is uniformly and smoothly coated on the outer side surface and/or the inner pore surface of the carboxylated carbon-based material. The material is rich in amino groups and is uniform and stable, can be used in the lithium-sulfur battery, and can effectively adsorb lithium polysulfide during a long cycle process.

This application claims benefits of priority of Chinese Patent Application No. 202010041044.4, filed to the China National Intellectual Property Administration on Jan. 15, 2020 and entitled “POLYAMINE-CARBON COMPOSITE MATERIAL, SLURRY, SEPARATOR, LITHIUM-SULFUR BATTERY AND PREPARATION METHOD THEREOF”, and of Chinese Patent Application No. 202010041072.6, filed to the China National Intellectual Property Administration on Jan. 15, 2020 and entitled “POLYAMINE COMPOSITE MATERIAL, SLURRY, SEPARATOR, ELECTRODE SHEET, LITHIUM-SULFUR BATTERY AND PREPARATION METHOD THEREOF”, the contents of which are incorporated by reference herein in their entireties.

### TECHNICAL FIELD

The present disclosure relates to the field of battery technologies, in particular to a polyamine composite material and a preparation method thereof, and a slurry, a separator, an electrode sheet and a lithium-sulfur battery containing the same.

### BACKGROUND

Lithium-sulfur batteries have a theoretical specific capacity of up to 1672 mAh/g and a theoretical energy density of up to 2600 Wh/kg, which are much higher than those of lithium-ion batteries commonly used today. In addition, their positive electrode material, sulfur, has abundant reserves, low cost, and is more environmentally friendly, it is an ideal novel electrode material. However, there are some limits to the development of the lithium-sulfur batteries. Among them, the main problem that affects the cycle performance of the lithium-sulfur batteries is that, during the discharge process, lithium polysulfide, an intermediate product in the lithium-sulfur batteries, will migrate from a positive electrode to a negative electrode, resulting in a “shuttle effect”, leading to a deterioration of the performance of the negative electrode, a reduction of positive electrode active material sulfur, thereby resulting in irreversible capacity loss.

Regarding the above problem, it is pointed out in some studies that by loading certain material containing heteroatoms such as oxygen, nitrogen, sulfur on a separator, lithium polysulfide is chemically adsorbed to limit its migration to the negative electrode, thereby inhibiting the “shuttle effect”. In traditional technologies, oxides, sulfides, etc. are mostly used as doping material, in which the content of heteroatoms is lower, and the adsorption effect on lithium polysulfide is not strong. Moreover, since such inorganic substances have poor film-forming properties, if such doping material is combined with an organic polymer membrane, there will be disadvantages of easy dispersion and shedding. In addition, after lithium polysulfide is adsorbed by the doping material, if the adsorbed lithium polysulfide does not continue to participate in the discharge, the utilization of the active material will also become lower.

### SUMMARY

In view of the above, it is necessary to provide a polyamine composite material being capable of effectively adsorbing lithium polysulfide, having strong film-forming properties, being firmly bonded to a main body and not easy to fall off, and having good conductivity, and a preparation method thereof, and a slurry, a separator, an electrode sheet and a lithium-sulfur battery prepared from the composite material, in order to improve the above-mentioned problems and enhance the electrochemical performance of lithium-sulfur batteries.

To solve the above-mentioned problems, the present disclosure provides a polyamine composite material. The polyamine composite material includes a carboxylated carbon-based material as a substrate and a polyamine as a surface layer, and the polyamine is uniformly and smoothly coated on an outer surface and/or an inner pore surface of the carboxylated carbon-based material.

The polyamine composite material uses the carboxylated carbon-based material as the substrate to enhance the conductivity of the overall material. The polyamine contains a large amount of nitrogen atoms, which can effectively adsorb lithium polysulfide. The polyamine is uniformly coated on the surface of the carbon-based material so as to make as much lithium polysulfide as possible to conduct electrons through the carbon-based material, which is beneficial for the lithium polysulfide to continue to fully participate in the charge and discharge process, and to improve the utilization of the active material. In addition, the polyamine has strong film-forming properties, which is beneficial to the subsequent formation of a continuous and stable separator coating layer. The polyamine composite material may be further prepared into a slurry and a separator, which can be applied to a lithium-sulfur battery to improve the cycle performance of the lithium-sulfur battery.

The present disclosure further provides a polyamine composite material including a carboxylated carbon-based material located in an innermost layer, sulfur located in an intermediate layer, and a polyamine located in an outermost layer. Sulfur is uniformly attached to an outer surface and/or an inner pore surface of the carboxylated carbon-based material, the polyamine is uniformly coated on a surface of sulfur, and part or all of amino groups on the polyamine and part or all of carboxyl groups on the carboxylated carbon-based material undergo a dehydration condensation to form bonding.

The polyamine composite material uses the carboxylated carbon-based material as a substrate, and sulfur is uniformly attached to the carbon-based material. The carbon-based material can solve the problem of poor conductivity of sulfur itself, improve the charge and discharge capacity of sulfur, and increase the specific discharge capacity of the active material sulfur. The polyamine is further coated on the sulfur layer, a large number of nitrogen atoms can effectively adsorb lithium poly sulfide to alleviate a “shuttle effect”, so that the lithium-sulfur battery can maintain a better cycle stability during long-cycle charge and discharge. More than that, the carboxyl group in the carboxylated carbon-based material and the amino group in the polyamine further undergo a dehydration condensation to form a stable chemical bond, which can inhibit the pulverization and shedding of the sulfur distributed between the polyamine and the carbon-based material, thereby reducing the specific capacity fading of the lithium-sulfur battery containing the polyamine composite material during cycling. The polyamine composite material may be further prepared into a slurry and an electrode sheet, which can be applied to a lithium-sulfur battery. The lithium-sulfur battery has an excellent long-cycle performance and has a good application prospect.

In an embodiment, sulfur is an elemental sulfur.

In an embodiment, the carboxylated carbon-based material is at least one selected from the group consisting of a carboxylated graphene oxide, a carboxylated carbon nanotube, a carboxylated graphite powder, a carboxylated carbon nanosphere, a carboxylated carbon nanorod, and a carboxylated carbon fiber.

In an embodiment, the polyamine is at least one selected from the group consisting of ethylene diamine, propylene diamine, hexamethylene diamine, p-phenylenediamine, m-phenylenediamine, polyethyleneimine, polyethyleneimine derivatives, chitosan, chitosan derivatives, dopamine, 2,3,6,7,10,11-hexaaminotriphenylene hexahydrochloride and triphenylene-2,3,6,7,10,11-hexaamine hexahydrochloride.

The present disclosure further provides a method for preparing a polyamine composite material, including the following steps:

step 1): mixing a polyamine aqueous solution with a dispersion liquid containing a carboxylated carbon-based material to obtain a mixed liquid; and

step 2): drying the mixed liquid, to obtain the polyamine composite material.

In an embodiment, the mixed liquid obtained in step 1) has a pH value of 5 to 9, optionally, a pH value of 6 to 8.

In an embodiment, the polyamine in the polyamine aqueous solution in step 1) has a concentration of 0.5 g/L to 1.5 g/L, optionally, a concentration of 0.8 g/L to 1.2 g/L.

In an embodiment, the drying in step 2) is in a form of blast drying, vacuum drying or freeze drying.

The present disclosure also provides another method for preparing a polyamine composite material, including the following steps:

step a): uniformly depositing sulfur on a carboxylated carbon-based material in a dispersion liquid containing the carboxylated carbon-based material, to obtain a sulfur-carbon composite material dispersion liquid;

step b): mixing a polyamine aqueous solution with the sulfur-carbon composite material dispersion liquid to obtain a mixed liquid;

step c): subject the mixed liquid to a hydrothermal reaction; and

step d): collecting a solid part of a product obtained from the hydrothermal reaction, drying and calcining to obtain the polyamine composite material.

In an embodiment, in step a), the uniformly depositing sulfur on the carboxylated carbon-based material includes: in the dispersion liquid containing the carboxylated carbon-based material, adding thiosulfate to react with an acid, so as to allow the produced sulfur to be uniformly deposited on the carboxylated carbon-based material.

In an embodiment, the sulfur-carbon composite material dispersion liquid in step a) has a pH value between 5 and 9. Optionally, the sulfur-carbon composite material dispersion liquid has a pH value of 6 to 8.

In an embodiment, after the polyamine aqueous solution is added into the sulfur-carbon composite material dispersion liquid in step b), it is necessary to stir the mixed liquid evenly and let it stand.

In an embodiment, the polyamine in the polyamine aqueous solution in step b) has a concentration of 0.5 g/L to 1.5 g/L, optionally, a concentration of 0.8 g/L to 1.2 g/L.

In an embodiment, the hydrothermal reaction in step c) is performed under a temperature of 160° C. to 200° C. for 6 h to 24 h.

In an embodiment, the drying in step d) is in a form of blast drying, vacuum drying or freeze drying.

In an embodiment, the calcining in step d) is performed under a protective gas atmosphere, a temperature of 150° C. to 250° C. for 6 h to 24 h.

The present disclosure also provides a slurry including a binder, a conductive agent, a solvent, and the polyamine composite material according to any one of the above-mentioned embodiments. The binder, the conductive agent, the solvent and the polyamine composite material are mixed to form a slurry mixture.

In an embodiment, the binder is at least one selected from the group consisting of polyvinylidene fluoride, polytetrafluoroethylene, polyvinyl alcohol, sodium alginate, sodium carboxymethyl cellulose, hydroxypropyl cellulose, chitosan, chitosan derivatives, fenugreek gum, and polybutyl acrylate.

In an embodiment, the conductive agent is at least one selected from the group consisting of a carbon nanotube, a reduced graphene, a graphite, a carbon fiber, a conductive carbon black, an acetylene black, and a Ketjen black.

The present disclosure also provides a separator including a separator body and a coating layer on one side of a surface of the separator body. The coating layer is a coating layer that is formed by coating the slurry according to the above embodiments to one side of the surface of the separator body and removing the solvent, or is a coating layer that is formed from the polyamine composite material according to the above embodiments, or is a coating layer that is formed from the polyamine composite material prepared by the method for preparing the polyamine composite material according to the above embodiments.

In an embodiment, the separator body is a separator body made of polytetrafluoroethylene, polyvinylidene fluoride, polyethylene or polypropylene.

The present disclosure also provides an electrode sheet including a current collector and an electrode material layer on the current collector. The electrode material layer is a coating layer that is formed from the above polyamine composite material containing the sulfur intermediate layer, or is a coating layer that is formed from the polyamine composite material containing the sulfur intermediate layer prepared by the above method for preparing the polyamine composite material, or is a coating layer that is formed by coating the above slurry containing sulfur to the current collector of the electrode sheet and removing the solvent.

The present disclosure also provides a lithium-sulfur battery including a positive electrode sheet, a negative electrode sheet, a separator and an electrolyte. The separator is arranged between the positive electrode sheet and the negative electrode sheet to separate the positive and negative electrode sheets. The electrolyte infiltrates the separator and the positive and negative electrode sheets, and the separator is the separator according to the above embodiments and one side of the separator containing the coating layer is close to the positive electrode sheet. Alternatively or additionally, the positive electrode sheet is the electrode sheet provided by the above embodiments.

### BRIEF DESCRIPTION OF THE DRAWINGS

FIG. 1 is a plot showing comparison of cycle performances of a lithium-sulfur battery prepared in Example 1 and a lithium-sulfur battery prepared in Comparative Example 1.

FIG. 2 is an electron microscope picture and elemental analysis picture of a polyamine composite material prepared in Example 1, wherein FIGS. 2(a) and 2(b) show electron microscope morphology pictures of the polyamine composite material with different magnifications, and FIGS. 2(c), 2(d) and 2(e) are diagrams showing distributions of carbon, nitrogen and oxygen in FIG. 2 (b), respectively.

FIG. 3 is a plot showing comparison of cycle performances of a lithium-sulfur battery prepared in Example 2 and a lithium-sulfur battery prepared in Comparative Example 2.

FIG. 4 is an electron microscope morphology picture of a carboxymethyl chitosan-sulfur-reduced graphene oxide composite material prepared in Example 2.

FIG. 5 is an X-ray photoelectron spectrogram of a polyamine composite sulfur positive electrode prepared in Example 2 tested after 200 cycles, and the results obtained by fitting the peaks in the figure indicate chemical bonds contained in the test substance.

### DETAILED DESCRIPTION OF THE EMBODIMENTS

In order to facilitate the understanding of the present disclosure, the present disclosure will be more fully described below with reference to the embodiments and the accompanying drawings. Preferable embodiments of the present disclosure are presented in examples. However, the present disclosure may be embodied in many different forms and is not limited to the examples described herein. Rather, these embodiments are provided so that the understanding of the present disclosure will be more thorough and complete.

All technical and scientific terms used herein have the same meaning as commonly understood by skilled person in the art to which this disclosure belongs, unless otherwise defined. The terms used in the specification of the present disclosure herein are for the purpose of illustration of specific embodiments only and are not intended to limit the present disclosure. The term “and/or” used herein includes any and all combinations of one or more of the associated listed items. As used herein, “multi’ represents two or more items.

An embodiment of the present disclosure provides a polyamine composite material. The polyamine composite material includes a carboxylated carbon-based material as a substrate and a polyamine as a surface layer, and the polyamine is uniformly coated on an outer surface and/or an inner pore surface of the carboxylated carbon-based material.

Optionally, the carboxylated carbon-based material is at least one selected from the group consisting of a carboxylated graphene oxide, a carboxylated carbon nanotube, a carboxylated graphite powder, a carboxylated carbon nanosphere, a carboxylated carbon nanorod, and a carboxylated carbon fiber. The polyamine is at least one selected from the group consisting of ethylene diamine, propylene diamine, hexamethylene diamine, p-phenylenediamine, m-phenylenediamine, polyethyleneimine and derivatives thereof, chitosan and derivatives thereof, dopamine, 2,3,6,7,10,11-hexaaminotriphenylene hexahydrochloride and triphenylene-2,3,6,7,10,11-hexaamine hexahydrochloride.

The carbon-based material functions as a conductive substrate, and may be in the form of flakes, balls, rods or irregular particles, and may be solid, porous or hollow. Depending on the morphology of the selected carbon-based material, the polyamine may also be coated on the outer surface, pore surface or hollow inner surface of the carbon-based material. In the present disclosure, there are two reasons for selecting polyamines as the coating material, one is that the proportion of nitrogen atoms in materials such as polyamines is relatively large, which means that in the case of same mass of addition, the adsorption performance of polyamines for lithium polysulfide is much better than other doping materials; another is that polyamines are generally soluble in water, have very good film-forming properties, and are easy to form a continuous, uniform and stable coating layer.

As an example, the carboxylated carbon-based material may be a carboxylated graphene oxide, and the polyamine may be a carboxymethyl chitosan. Both of the above-mentioned materials have been commercialized at present, and are relatively simple to prepare and relatively inexpensive, and have good application prospects. In addition, the carboxylated carbon-based material may also be obtained by self-preparation. A simple preparation method is to mix a strong oxidizing acid with the carbon-based material and then heat the mixture to reflux, and the preparation process is also relatively simple.

The polyamine composite material provided in the above embodiments may be applied to the separator of lithium-sulfur batteries. The composite material uses the carbon-based material with good conductivity as the substrate, and the polyamine is uniformly coated on the carbon-based material. When nitrogen atoms on the polyamine adsorb the lithium polysulfide, an intermediate product of the lithium-sulfur battery, it may also provide a better conductive network, enabling the adsorbed lithium polysulfide to still participate in the discharge process. Thus, the specific discharge capacity of the lithium-sulfur battery during the cycle is increased and the capacity fading is reduced.

Another embodiment of the present disclosure provides a polyamine composite material including a carboxylated carbon-based material located in an innermost layer, sulfur located in an intermediate layer, and a polyamine located in an outermost layer. Sulfur is uniformly attached to an outer surface and/or an inner pore surface of the carboxylated carbon-based material, the polyamine is uniformly coated on a surface of sulfur, and part or all of amino groups on the polyamine and part or all of carboxyl groups on the carboxylated carbon-based material undergo a dehydration condensation to form a bonding.

In this embodiment, sulfur located in the intermediate layer refers to an elemental sulfur. Specifically, it may be a sublimated sulfur powder that can be conventionally purchased directly from the market, or a nano-sulfur powder. It may also be a self-prepared sulfur, for example, the elemental sulfur is prepared by reacting thiosulfate ions with hydrogen ions in a solution.

In this embodiment, the carboxylated carbon-based material and the polyamine are as defined above. It should be understood that the carbon-based material of this embodiment is used to load sulfur, and sulfur may be attached to the outer surface, pore surface, and/or inner surface of the hollow portion of the carbon-based material. The polyamine plays two roles in the composite material of this embodiment, one is that the abundant nitrogen atoms on the polyamine may effectively adsorb lithium polysulfide to alleviate the “shuttle effect”, and the other is that dehydration condensation may occur between amino groups and carboxyl groups to produce bonding, enhancing the stability of the overall structure.

The polyamine composite material of this embodiment has a good electrochemical performance and may be applied to the electrode sheet of lithium-sulfur batteries. Specifically, the polyamine composite material uses the carbon-based material as the substrate, and sulfur is uniformly loaded on the carbon-based material, which enhances the conductivity between sulfur and the current collector, and makes sulfur discharge more fully. The polyamine is located in the outermost layer of the composite material, and the lithium polysulfide generated by sulfur in the intermediate layer during the discharge process must diffuse out through the polyamine layer, and it will be adsorbed and captured by a large number of nitrogen atoms on the polyamine during the process of passing through the polyamine layer, which in turn alleviates the “shuttle effect” of lithium polysulfide. Moreover, a stable bonding is formed between the polyamine and the carbon-based material, to enhance the stability of the overall structure of the material, whereas as an intermediate layer, sulfur is sandwiched between the polyamine and the carbon-based material and is not easy to detach, thus the cases such as pulverization and shedding are suppressed, and the loss of active materials during the charge and discharge process is reduced, ultimately improving the long-cycle stability of the lithium-sulfur battery.

The present disclosure further provides a method for preparing a polyamine composite material, in an embodiment, including the following steps.

In step 1), a polyamine aqueous solution is mixed with a dispersion liquid containing a carboxylated carbon-based material to obtain a mixed liquid.

It is easy to understand that the two raw materials are mixed in the aqueous solution in order to make the raw materials to be dispersed more uniformly and to make the two raw materials to be contacted with each other more fully. Therefore, the solution may be dispersed under sonication and/or stirring at the same time. Another purpose of mixing in the aqueous solution is that after the polyamine is dissolved in water, amino groups therein can be positively charged by hydrolysis, and carboxyl groups are negatively charged after ionized in water. Thus, the polyamine may easily achieve a uniform coating on the carboxylated carbon-based material through an electrostatic adsorption between ions, which greatly simplifies the preparation process. Moreover, according to the above principle, the degree of hydrolysis of amino groups or ionization of carboxyl groups in the solution may also be controlled by adjusting a pH value, so as to maintain the stability and controllability of the adsorption. Optionally, the pH value of the above mixed liquid is between 5 and 9, more specifically, it may be between 6 and 8. Depending on the proportions of the total amounts of the carboxylated carbon-based material and the polyamine, the pH value may be adjusted by adding a sodium hydroxide solution or a hydrochloric acid solution dropwise.

As an example, step 1) may be implemented as follows: the polyamine aqueous solution is added to an aqueous dispersion of the carboxylated carbon-based material, and magnetic stirring and ultrasonic dispersion are performed, while the sodium hydroxide solution and hydrochloric acid are added dropwise to control the pH value of the solution to be 6 to 8. The concentration of the polyamine aqueous solution may be 0.5 g/L to 1.5 g/L, more specifically, is 0.8 g/L to 1.2 g/L.

In step 2), the mixed liquid is dried to obtain the polyamine composite material.

The drying may be in a form of blast drying, vacuum drying or freeze drying. The advantage of blast drying and vacuum drying is higher drying efficiency, but the disadvantage is that the drying process may be accompanied by heating, and the overall polyamine composite material may shrink, or the materials are bonded too firmly to be pulverized. Freeze drying may maintain a looser structure of the polyamine composite material. The obtained polyamine composite material may further be pulverized by means such as grinding for ease of subsequent use.

The above preparation method is simple and feasible, and is easy to obtain a carboxylated carbon-based material uniformly coated with the polyamine, and has high practical value.

The present disclosure also provides another method for preparing a polyamine composite material, in an embodiment, including the following steps.

In step a), sulfur is uniformly deposited on a carboxylated carbon-based material in a dispersion liquid containing the carboxylated carbon-based material, to obtain a sulfur-carbon composite material dispersion liquid.

Optionally, sulfur is uniformly deposited on the carboxylated carbon-based material in the following way: in the dispersion liquid containing the carboxylated carbon-based material, thiosulfate is added to react with an acid, so as to allow the produced sulfur to be deposited on the carboxylated carbon-based material. More specifically, sodium thiosulfate may be firstly added to the carboxylated carbon-based material dispersion liquid, and after uniformly stirring, hydrochloric acid is added dropwise to react and stirring is continued. It can be understood that the nature of the generation of sulfur in this step is the reaction of hydrogen ions and thiosulfate ions. Therefore, the acid used may also be other inorganic or organic acids, such as sulfuric acid, nitric acid, acetic acid, etc., and sodium thiosulfate used may also be adjusted as other compounds that can provide thiosulfate ions in an aqueous solution as desired.

The first stirring is to fully dissolve and uniformly disperse sodium thiosulfate, and the continued stirring is to allow the generated sulfur to be uniformly attached to the carboxylated carbon-based material.

Furthermore, when sulfur is uniformly deposited on the carboxylated carbon-based material, the pH of the dispersion liquid may be controlled to be 5 to 9 in order to maintain the stability of the carboxyl groups on the carbon-based material and the amino groups on the polyamine added subsequently. For example, according to the pH value of the dispersion liquid at that moment, the pH value is adjusted as 8 by adding sodium hydroxide solution or hydrochloric acid solution dropwise.

In step b), a polyamine aqueous solution is added into the sulfur-carbon composite material dispersion liquid to obtain a mixed liquid.

Specifically, step b) may be performed in the following way: the polyamine aqueous solution is added dropwise to the sulfur-carbon composite material dispersion obtained in step a), and stirring and/or ultrasonic treatment are/is performed simultaneously to allow it to be dispersed uniformly. The polyamine is positively charged in the aqueous solution, and the carboxyl group is negatively charged in the aqueous solution, both of which may adsorb each other under the electrostatic interaction to form a polyamine sulfur-carbon composite structure preliminarily. The purpose of stirring and/or ultrasonic treatment is to allow polyamine molecules to be uniformly coated on the surface of the sulfur-carbon composite material.

Optionally, the polyamine in the polyamine aqueous solution may have a concentration of 0.5 g/L to 1.5 g/L. More specifically, the polyamine in the polyamine aqueous solution has a concentration of 0.8 g/L to 1.2 g/L. The concentration of the polyamine should not be too high or too low. Being too high may result in excessive liquid viscosity, and a uniform coating layer cannot be formed, and the proportion of the polyamine in the final material will be too high, which affects the conductivity of the polyamine composite material. Being too low may result in too little polyamines in the final material, and effective adsorption of lithium polysulfide cannot be realized.

In step c), the mixed liquid is subjected to a hydrothermal reaction.

Optionally, the hydrothermal reaction is performed under a temperature of 160° C. to 200° C. for 6 h to 24 h. More specifically, the hydrothermal reaction may be performed under a temperature of 180° C. for 18 h. On the one hand, the hydrothermal reaction may allow sulfur to be melted at a high temperature, and to be infiltrated and distributed between the reduced graphene oxide and polyamine uniformly. On the other hand, it may result in dehydration condensation reaction of the amino groups in the polyamine and the carboxyl groups of the graphene oxide to form a stable chemical bonding, and finally a stable polyamine sulfur-carbon composite structure is obtained. Furthermore, the excess carboxyl groups on the carbon-based materials may be reduced at a high temperature, and the conductivity of the carbon-based material can be enhanced.

In step d), a solid part of a product obtained from the hydrothermal reaction is collected, dried and calcined to obtain the polyamine composite material.

The solid part of the product obtained from the hydrothermal reaction may be collected by centrifugation or filtration. The drying may be in a form of blast drying, vacuum drying, or freeze drying.

Optionally, the calcining is performed in an argon atmosphere at a temperature of 150° C. to 250° C. for 6 h to 24 h. More specifically, the calcining is performed at a temperature of 155° C. for 12 h. Calcining may allow sulfur to be melted and further dispersed uniformly on the carbon-based material.

In the above-mentioned preparation method, sulfur is dispersed more uniformly by the coordination of three steps of deposition in liquid phase, hydrothermal reaction, and high-temperature calcination, which facilitates the improvement the charge and discharge capacity of sulfur. The amino groups on the polyamine and the carboxyl groups on the carbon-based material may undergo a condensation reaction by the hydrothermal reaction to form an amide bond, so as to obtain a more stable composite material. Moreover, the excess carboxyl groups on the carbon-based material are reduced by the hydrothermal reaction, and the conductivity of the carbon-based material can be improved.

An embodiment of the present disclosure also provides a slurry including a binder, a conductive agent, a solvent, and the polyamine composite material obtained according to the above preparation method. The binder, the conductive agent, the solvent and the polyamine composite material are uniformly mixed to form a slurry mixture.

Optionally, the binder may be at least one selected from the group consisting of polyvinylidene fluoride, polytetrafluoroethylene, polyvinyl alcohol, sodium alginate, sodium carboxymethyl cellulose, hydroxypropyl cellulose, chitosan, chitosan derivatives, fenugreek gum, and polybutyl acrylate. The conductive agent may be at least one selected from the group consisting of a carbon nanotube, a reduced graphene, a graphite, a carbon fiber, a conductive carbon black, an acetylene black and a Ketjen black. The solvent may be water or an organic solvent such as N-methyl pyrrolidone, as long as it can dissolve the selected binder well. A method of mixing may be ball milling, defoaming centrifugation, or may be stirring or ultrasonic dispersion, or may be a combination of the above methods.

An embodiment of the present disclosure further provides a separator. The separator includes a separator body and a coating layer on one side of a surface of the separator body, wherein the coating layer is a coating layer that is formed by coating the slurry according to the above embodiments to one side of the surface of the separator body and removing the solvent, or is a coating layer that is formed from the polyamine composite material according to the above embodiments, or is a coating layer that is formed from the polyamine composite material prepared by the above method for preparing the polyamine composite material.

The separator may be a polymer porous separator, such as a separator body made of polytetrafluoroethylene, polyvinylidene fluoride, polyethylene or polypropylene, as long as it can separate the positive and negative electrodes of the battery to prevent short-circuit of the positive and negative electrodes, and can be infiltrated by an electrolyte to provide a channel for ion transmission.

An embodiment of the present disclosure also provides an electrode sheet including a current collector and an electrode material layer on the current collector. The electrode material layer is a coating layer that is formed from the polyamine composite material containing the sulfur intermediate layer, or is a coating layer that is formed from the polyamine composite material containing the sulfur intermediate layer prepared by the above method for preparing the polyamine composite material, or is a coating layer that is formed by coating the above slurry containing sulfur to the current collector of the electrode sheet and removing the solvent.

The separator and electrode sheet provided in the above embodiments can be applied to a lithium-sulfur battery. For example, in an embodiment, the lithium-sulfur battery includes a positive electrode sheet, a negative electrode sheet, a separator and an electrolyte. The separator is arranged between the positive electrode sheet and the negative electrode sheet to separate the positive and negative electrode sheets. The electrolyte infiltrates the separator and the positive and negative electrode sheets, and the separator is the separator provided by the above embodiments and one side of the separator containing the coating layer is close to the positive electrode sheet. In some embodiments, the positive electrode sheet is the electrode sheet provided by the above embodiments.

It is necessary to allow the side coated with the coating layer of the separator to be close to the positive electrode sheet, because electrons need to be further conducted through the carbon material in the coating layer after lithium polysulfide is adsorbed by the coating layer, so that the adsorbed lithium polysulfide may continue to participate in charge and discharge to improve the utilization of active material. That is to say, the structure in which polyamines are uniformly coated on the carbon-based material can allow the material to adsorb lithium polysulfide and conduct electrons simultaneously.

As a specific example, the negative electrode sheet may be a conventional lithium sheet negative electrode or a lithium-copper composite tape, and the electrolyte may be selected from ethers electrolyte, esters electrolyte or other electrolytes reported in the prior art. The type of lithium-sulfur battery may also be freely selected, such as a button battery, a pouch battery, a concentric rod battery, etc. The assembling method should be selected depending on the types of batteries, which will not be detailed herein.

In order to facilitate the understanding of the content of the embodiments, the polyamine composite separator of the present disclosure and the preparation method thereof will be described in further detail. The following are specific Examples and Comparative Examples based on the embodiments. According to the following embodiments and effect tests, the superiority of the present disclosure will be apparent.

Unless otherwise specified, the raw materials used in the following Examples and Comparative Examples can be conventionally purchased from the market.

In step 1), a carboxymethyl chitosan aqueous solution was mixed with a carboxylated graphene oxide dispersion liquid, magnetically stirred for 0.5 h, and ultrasonically dispersed for 0.5 h until the mixture became uniform, and the pH value of the mixed liquid was controlled to be between 6 and 8. Wherein, the concentration of the carboxymethyl chitosan aqueous solution was 1.0 g/L, the concentration of the graphene oxide dispersion liquid was 5 g/L, and the volume ratio of the carboxymethyl chitosan aqueous solution to the carboxylated graphene oxide dispersion liquid was 1:1.

In step 2), the mixed solution was freeze-dried, and after the drying was completed, it was ground until no obvious particles were visible to the naked eye, and a carboxymethyl chitosan-reduced graphene oxide composite material was obtained.

In step 3), the carboxymethyl chitosan-reduced graphene oxide composite material, acetylene black, and polyvinylidene fluoride were blended into a slurry in a mass ratio of 6:2:2 and coated on one side of a polypropylene separator to obtain a carboxymethyl chitosan-reduced graphene oxide/polypropylene separator, which was then dried and cut into a circular separator as the separator of the lithium-sulfur battery.

### Comparative Example 1

The difference between Comparative Example 1 and Example 1 is only that a polypropylene separator was directly used as the separator of the lithium-sulfur battery in Comparative Example 1.

The method for assembling lithium-sulfur batteries in Example 1 and Comparative Example 1 were as follows:

Sulfur-acetylene black composite material was used as the positive electrode material, a metal lithium sheet was used as the negative electrode material, and the electrolyte was a mixture of 1 M lithium bis (trifluoromethanesulphonyl)imide dissolved in 1,3-dioxolane/glycol dimethyl ether (in a volume ratio of 1:1).

### Example 2

In step 1), 10 g of sodium thiosulfate was added into 40 mL of graphene oxide solution with a concentration of 5 g/L, and stirred for 0.5 h, then a uniform mixed solution was obtained. 2 M hydrochloric acid was added dropwise and stirring was continued for 0.5 h, then a sodium hydroxide solution was added dropwise to adjust the pH to 8, and then a sulfur-carbon composite material dispersion liquid was obtained.

In step 2), 100 mL of carboxymethyl chitosan aqueous solution with a concentration of 1.0 g/L was added to the sulfur-carbon composite material dispersion liquid, stirred for 0.5 h and then let it stand for 12 h to obtain a mixed liquid.

In step 3), the mixed liquid was transferred to a hydrothermal reactor, and a hydrothermal reaction was carried out at 180° C. for 18 h.

In step 4), the mixture obtained from the hydrothermal reaction was vacuum filtered and washed until the washing liquid became colorless and clear. Then a solid was obtained and freeze-dried and then calcined in a tube furnace filled with argon at a calcination temperature of 155° C. for 12 h with a heating rate of 3° C./min. After calcination, the solid was taken out and ground to obtain a carboxymethyl chitosan-sulfur-reduced graphene oxide composite material.

In step 5), the carboxymethyl chitosan-sulfur-reduced graphene oxide composite material, acetylene black and polyvinylidene fluoride were blended into a slurry in a ratio of 8:1:1 using N-methyl pyrrolidone as a solvent, then coated on an aluminum foil or a carbon-coated aluminum foil, dried and cut into circular pole pieces.

In step 6), the circular pole pieces were used to assemble a button-type lithium-sulfur battery. Wherein, the negative electrode material was a metal lithium sheet, the separator was a polypropylene separator, and the electrolyte was 1 M of lithium bis(trifluoromethanesulphonyl)imide dissolved in 1,3-dioxolane/glycol dimethyl ether (in a volume ratio of 1:1).

### Comparative Example 2

In step 1), 10 g of sodium thiosulfate was added into 40 mL of graphene oxide solution with a concentration of 5 g/L, and stirred for 0.5 h, then a uniform mixed solution was obtained. 2 M hydrochloric acid was added dropwise and stirring was continued for 0.5 h, then a sodium hydroxide solution was added dropwise to adjust the pH to 8, and then a sulfur-carbon composite material dispersion liquid was obtained.

In step 2), a deionized water was added to the sulfur-carbon composite material dispersion liquid, stirred for 0.5 h and then let it stand for 12 h to obtain a mixed liquid.

In step 3), the mixed liquid was transferred to a hydrothermal reactor, and a hydrothermal reaction was carried out at 180° C. for 18 h.

In step 4), the mixture obtained from the hydrothermal reaction was vacuum filtered and washed until the washing liquid become colorless and clear. Then a solid was obtained and freeze-dried and then calcined in a tube furnace filled with argon at a calcination temperature of 155° C. for 12 h with a heating rate of 3° C./min. After calcination, the solid was taken out and ground to obtain a sulfur-reduced graphene oxide composite material.

In step 5), the sulfur-reduced graphene oxide composite material, acetylene black and polyvinylidene fluoride were blended into a slurry in a ratio of 8:1:1 using N-methyl pyrrolidone as a solvent, then coated on an aluminum foil or a carbon-coated aluminum foil, dried and cut into circular pole pieces.

In step 6), the circular pole pieces were used to assemble a button-type lithium-sulfur battery. Wherein, the negative electrode material was a metal lithium sheet, the separator was a polypropylene separator, and the electrolyte was 1 M of lithium bis(trifluoromethanesulphonyl)imide dissolved in 1,3-dioxolane/glycol dimethyl ether (in a volume ratio of 1:1).

The only difference between Example 2 and Comparative Example 2 was that the liquid added in step 2) of Example 2 was 100 mL of carboxymethyl chitosan aqueous solution with a concentration of 1.0 g/L, while liquid added in step 2) of Comparative Example 2 was 100 mL of deionized water. Example 2 and Comparative Example 2 were used to verify the effect of carboxymethyl chitosan on the specific discharge capacity and long-cycle performance of the lithium-sulfur battery.

Cycle stability and charge-discharge specific capacity were two important indicators for evaluating battery performance. The above Examples and Comparative Examples were all subjected to 3 performance tests under a condition of 0.5 C and voltage ranging from 1.7 V to 2.8 V. The middle value of the 3 test results was taken.

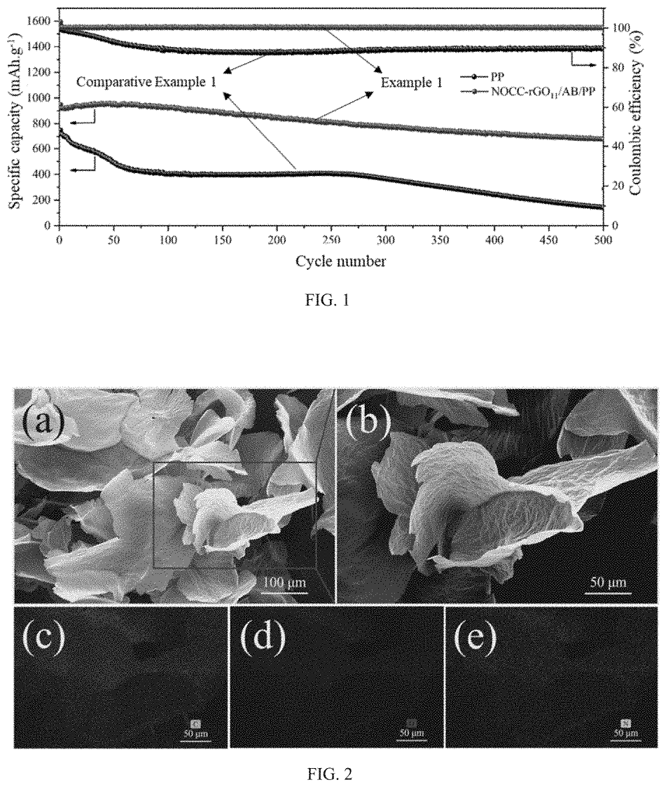

FIG. 1 shows the results of cycle tests of the batteries of Example 1 and Comparative Example 1. According to FIG. 1, it can be clearly found that in the case of similar initial specific discharge capacities, the initial capacity of Example 1 containing the polyamine composite material is 948.7 mAh/g, and the battery capacity becomes 677.9 mAh/g after 500 cycles, thus, 71% of specific discharge capacity is retained. While the initial capacity of the battery in Comparative Example 1 is 749.2 mAh/g, and the capacity becomes only 142.4 mAh/g after 500 cycles, thus, the retention rate of the specific discharge capacity is only 19%. The capacity fading of Example 1 is much lower than that of Comparative Example 1. At the same time, the coulombic efficiency of the battery of Example 1 is also much higher than that of Comparative Example 1. Especially, as the number of test cycles increases, the coulombic efficiency of Example 1 always remains close to 100%, while the coulombic efficiency of Comparative Example 1 drops significantly, as only 97%. Based on the above comparison results, it can be known that the polyamine composite separator provided by the present disclosure effectively alleviates the “shuttle effect” of the lithium-sulfur battery.

FIG. 2 (a) and FIG. 2 (b) show the microscopic morphologies of the carboxymethyl chitosan-loaded graphene oxide flakes. FIGS. 2(c), 2(d) and 2(e) are diagrams showing the distributions of carbon, nitrogen and oxygen in FIG. 2 (a), respectively. The areas where nitrogen and carbon are located overlap with each other, which indicates that the polyamine is indeed uniformly loaded on the graphene oxide.

The polyamine composite separator provided by the present disclosure includes the polyamine rich in amino groups and the carbon-based material rich in carboxyl groups, which synergizes the effect. The material has high proportions of nitrogen atoms in a large number of amino groups and oxygen atoms in a large number of carboxyl groups, which may effectively adsorb lithium polysulfide and alleviate the “shuttle effect” of lithium polysulfide. Furthermore, an electrostatic adsorption effect may also be generated between the amino groups and the carboxyl groups, which is beneficial to the bonding between them, and the prepared polyamine composite separator is uniform and stable. The polyamine composite separator also has the advantages such as, environmental protection and easy availability of raw materials, low cost, simple preparation process, and suitability for commercial production, and the battery assembled from it has a low cycle capacity fading rate and has good application prospects.

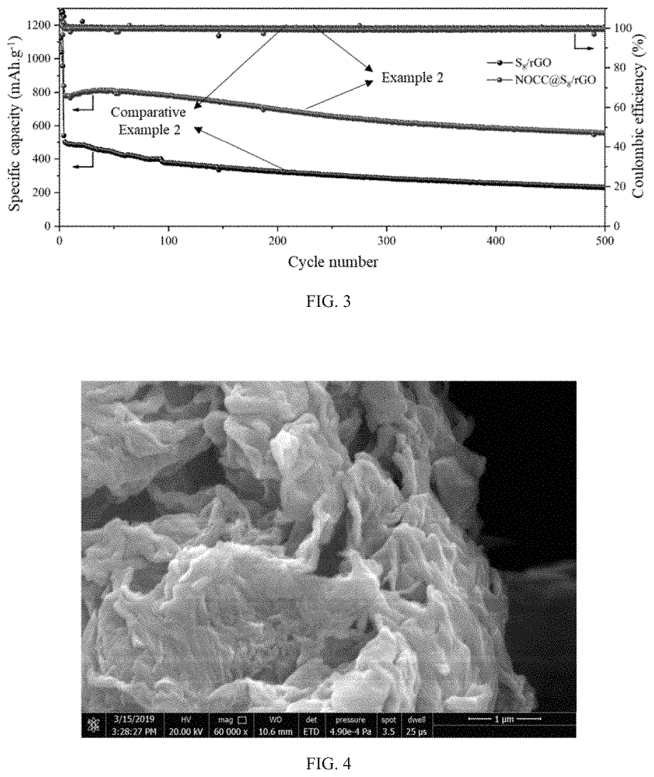

It can be seen from the test results in FIG. 3 that, the lithium-sulfur battery including the carboxymethyl chitosan-sulfur-reduced graphene oxide composite positive electrode prepared in Example 2 exhibits a first-cycle specific discharge capacity of 838 mAh/g after being activated. After 500 cycles of charge and discharge, the specific discharge capacity of 554 mAh/g can still be maintained, the capacity retention rate is 66%, and the average capacity fading rate per cycle is 0.068%. While the lithium-sulfur battery including the sulfur-reduced graphene oxide composite positive electrode prepared in Comparative Example 2 exhibits a first-cycle specific discharge capacity of only 541 mAh/g. After 500 cycles of charge and discharge, the specific discharge capacity is only 230 mAh/g, the capacity retention rate is only 42%, and the average capacity fading rate per cycle is 0.116%. The specific discharge capacity and cycle performance of the positive electrode added with carboxymethyl chitosan are significantly better than those of the positive electrode without addition, which demonstrates that the polyamine composite material of the present disclosure can effectively improve the electrochemical performance of lithium-sulfur batteries when applied to lithium-sulfur batteries.

FIG. 4 is an electron microscope picture of the carboxymethyl chitosan-sulfur-reduced graphene oxide composite material prepared in Example 2.

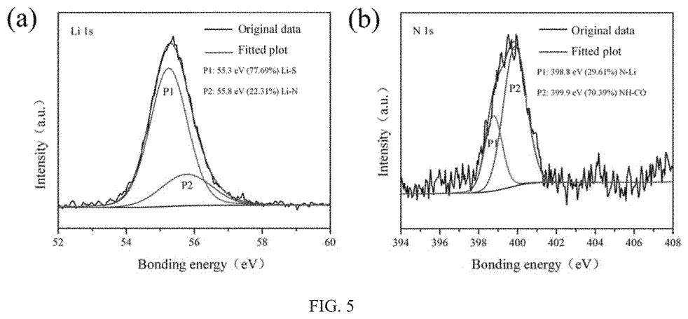

FIG. 5 (a) is an element analysis diagram for lithium by X-ray photoelectron spectroscopy in the positive electrode of the lithium-sulfur battery including the polyamine composite material after 200 cycles, and FIG. 5 (b) is an element analysis diagram for nitrogen. The peak P2 in FIG. 5 (a) indicates that there is bonding between the lithium atoms and the nitrogen atoms, which demonstrates that the nitrogen atoms have a chemisorption effect on lithium polysulfide. The peak P2 in FIG. 5 (b) indicates the amide bond formed by the reaction between the carboxyl groups and the amino groups, which demonstrates that bonding reactions indeed occur between the carboxyl groups and the amino groups in the prepared polyamine-sulfur positive electrode.

Each of the technical features of the above-mentioned embodiments may be combined arbitrarily. To simplify the description, not all the possible combinations of each of the technical features in the above embodiments are described. However, all of the combinations of these technical features shall be considered to be within the scope of this disclosure, as long as such combinations do not contradict with each other.

The above-mentioned embodiments are merely illustrative of several embodiments of the present disclosure, which are described specifically and in detail, but it cannot be understood to limit the scope of the present disclosure. It should be noted that, for those ordinary skilled in the art, several variations and improvements may be made without departing from the concept of the present disclosure, and all of which are within the protection scope of the present disclosure. Therefore, the protection scope of the present disclosure shall be defined by the appended claims.

What is claimed is:

1. A polyamine composite material comprising a carboxylated carbon-based material as a substrate and a polyamine as a surface layer, wherein the polyamine is uniformly coated on an outer surface and/or an inner pore surface of the carboxylated carbon-based material.

2. A polyamine composite material comprising a carboxylated carbon-based material located in an innermost layer, sulfur located in an intermediate layer, and a polyamine located in an outermost layer, wherein sulfur is uniformly attached to an outer surface and/or an inner pore surface of the carboxylated carbon-based material, the polyamine is uniformly coated on a surface of sulfur, and part or all of amino groups on the polyamine and part or all of carboxyl groups on the carboxylated carbon-based material undergo a dehydration condensation to form bonding.

3. The polyamine composite material according to claim 1 or 2, wherein the carboxylated carbon-based material is at least one selected from the group consisting of a carboxylated graphene oxide, a carboxylated carbon nanotube, a carboxylated graphite powder, a carboxylated carbon nanosphere, a carboxylated carbon nanorod, and a carboxylated carbon fiber; and/or
the polyamine is at least one selected from the group consisting of ethylene diamine, propylene diamine, hexamethylene diamine, p-phenylenediamine, m-phenylenediamine, polyethyleneimine, polyethyleneimine derivatives, chitosan, chitosan derivatives, dopamine, 2,3,6,7,10,11-hexaaminotriphenylene hexahydrochloride and triphenylene-2,3,6,7,10,11-hexaamine hexahydrochloride.

4. A method for preparing a polyamine composite material, comprising steps of:
1) mixing a polyamine aqueous solution with a dispersion liquid containing a carboxylated carbon-based material to obtain a mixed liquid; and
2) drying the mixed liquid.

5. A method for preparing a polyamine composite material, comprising steps of:
a) uniformly depositing sulfur on a carboxylated carbon-based material in a dispersion liquid containing the carboxylated carbon-based material, to obtain a sulfur-carbon composite material dispersion liquid;
b) mixing a polyamine aqueous solution with the sulfur-carbon composite material dispersion liquid to obtain a mixed liquid;
c) subject the mixed liquid to a hydrothermal reaction; and
d) collecting a solid part of a product obtained from the hydrothermal reaction, drying and then calcining.

6. The method for preparing a polyamine composite material according to claim 4, wherein in step 1), the mixed liquid has a pH value of 5 to 9.

7. The method for preparing a polyamine composite material according to claim 5, wherein in step a), the uniformly depositing sulfur on the carboxylated carbon-based material comprises: in the dispersion liquid containing the carboxylated carbon-based material, adding thiosulfate to react with an acid, so as to allow the produced elemental sulfur to be uniformly deposited on the carboxylated carbon-based material, wherein the sulfur-carbon composite material dispersion liquid has a pH value of 5 to 9.

8. The method for preparing a polyamine composite material according to claim 4 or 5, wherein the polyamine in the polyamine aqueous solution has a concentration of 0.5 g/L to 1.5 g/L.

9. The method for preparing a polyamine composite material according to claim 5, wherein in step c), the hydrothermal reaction is performed under a temperature of 160° C. to 200° C. for 6 h to 24 h.

10. A slurry comprising a binder, a conductive agent, a solvent, and the polyamine composite material according to any one of claims 1 to 3, wherein the binder, the conductive agent, the solvent and the polyamine composite material are mixed to form a slurry mixture.

11. The slurry according to claim 10, wherein the binder is at least one selected from the group consisting of polyvinylidene fluoride, polytetrafluoroethylene, polyvinyl alcohol, sodium alginate, sodium carboxymethyl cellulose, hydroxypropyl cellulose, chitosan, chitosan derivatives, fenugreek gum and polybutyl acrylate; and/or
the conductive agent is at least one selected from the group consisting of a carbon nanotube, a reduced graphene, a graphite, a carbon fiber, a conductive carbon black, an acetylene black and a Ketjen black.

12. A separator comprising a separator body and a coating layer on one side of a surface of the separator body, wherein the coating layer is a coating layer that is formed from the polyamine composite material of claim 1, or is a coating layer that is formed from the polyamine composite material prepared by the method for preparing the polyamine composite material according to claim 4, or is a coating layer that is formed by coating the slurry of claim 10 depending on claim 1 to one side of the surface of the separator body and removing the solvent.

13. The separator according to claim 12, wherein the separator body is a separator body made of polytetrafluoroethylene, polyvinylidene fluoride, polyethylene or polypropylene.

14. An electrode sheet comprising a current collector and an electrode material layer on the current collector, wherein the electrode material layer is a coating layer that is formed from the polyamine composite material of claim 2, or is a coating layer that is formed from the polyamine composite material prepared by the method for preparing the polyamine composite material according to claim 5, or is a coating layer that is formed by coating the slurry of claim 10 depending on claim 2 to the current collector of the electrode sheet and removing the solvent.

15. A lithium-sulfur battery comprising a positive electrode sheet, a negative electrode sheet, a separator and an electrolyte, wherein the separator is arranged between the positive electrode sheet and the negative electrode sheet to separate the positive and negative electrode sheets, the electrolyte infiltrates the separator and the positive and negative electrode sheets, wherein, the separator is the separator according to claim 12 or 13 and one side of the separator containing the coating layer is close to the positive electrode sheet, and/or the positive electrode sheet is the electrode sheet according to claim 14.
